(19) United States
(12) Patent Application Publication
(10) Pub. No.: US 2026/0062306 A1
(43) Pub. Date: Mar. 5, 2026

(54) METHOD OF PROCESSING ALUM PROCESS RESIDUE

(71) Applicant: Chemtrade Chemicals US LLC, Parsippany, NJ (US)

(72) Inventors: Levi GROVE, Fairview Heights, IL (US); Paulo KAPRONCZAI, Calgary (CA); Stephane SOULIE, Quebec (CA); Francois TANGUAY, Levis (CA); Scott ROOK, Conroe, TX (US); Karan AGARWAL, Savannah, GA (US); Stanley NAZARIO, Evans, GA (US); Jonathan ADAMS, Lincolnton, GA (US); Thomas PYLE, Edgefield, SC (US)

(73) Assignee: Chemtrade Chemicals US LLC, Parsippany, NJ (US)

(21) Appl. No.: 19/306,281

(22) Filed: Aug. 21, 2025

Related U.S. Application Data
(60) Provisional application No. 63/689,679, filed on Aug. 31, 2024.

(51) Int. Cl. C01F 7/745; B01J 20/20; G05D 9/12; G05D 23/19

(52) U.S. Cl. CPC C01F 7/745; B01J 20/20; G05D 9/12; G05D 23/19

(57) ABSTRACT

The present disclosure is directed to apparatus and method for more efficiently and effectively refining alum process residue into commercially useable compounds. Materials that contain aluminum or aluminum oxide are provided to a vessel where a chemical rection is controlled when a product is made. Materials that include aluminum can be provided to the vessel and acid can also be provided to the vessel to initiate a chemical reaction. Masses of respective materials provided to the vessel can be controlled according to a regimen for making a product. Temperatures of the vessel can be monitored and controlled while the reaction occurs. Activated carbon may be added to the vessel to help the product performance and stability. Once the product is formed, it is output from the vessel and cooled. The product can be subsequently processed using techniques such as grinding and screening when a final product is prepared.

### CROSS-REFERENCE TO RELATED APPLICATIONS

This application claims benefit of U.S. Provisional Application No. 63/689,679 filed Aug. 31, 2024, which is incorporated herein by reference.

### TECHNICAL FIELD

The present disclosure is generally directed to improving how alum process residue is post-processed. More specifically, the present disclosure is directed to producing products from aluminum containing materials that better suit the needs of people and that generally improve environmental outcomes associated with the use of those products.

### BACKGROUND

Materials from which industrial grade products can be made can be reclaimed and/or recycled from the mud/sludge produced in alum (aluminum sulfate) production. These industrial grade products may also be made using materials like bauxite that contain aluminum oxide.

### BRIEF DESCRIPTION OF THE DRAWINGS

In order to describe the manner in which the features and advantages of this disclosure can be obtained, a more particular description is provided with reference to specific implementations thereof and which are illustrated in the appended drawings. Understand that these drawings depict only exemplary implementations of the disclosed technology and are therefore not to be considered limiting to the technology's scope as the principles described herein are depicted as illustrative examples in the accompanying drawings in which:

FIG. 1 illustrates a system that may be used when processing alum process residue sludge into useable compounds, in accordance with various aspects of the subject technology;

FIG. 2 illustrates a series of actions that may be performed when a product is made from materials that include aluminum, in accordance with various aspects of the subject technology;

FIG. 3 illustrates actions that may be performed when a product is made from aluminum containing materials, in accordance with various aspects of the subject technology;

FIG. 4 illustrates operations that may be performed by a system that controls operations of an alum processing facility, in accordance with various aspects of the subject technology;

FIG. 5 illustrates actions of machine learning process that allows for the operation of a computer model to be updated, in accordance with various aspects of the subject technology; and

FIG. 6 illustrates an example computing device architecture which can be employed to perform any of the systems and techniques described herein.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous compounds. In addition, numerous specific details are set forth in order to provide a thorough understanding of the methods and apparatus described herein. However, it will be understood by those of ordinary skill in the art that the methods and apparatus described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the present disclosure.

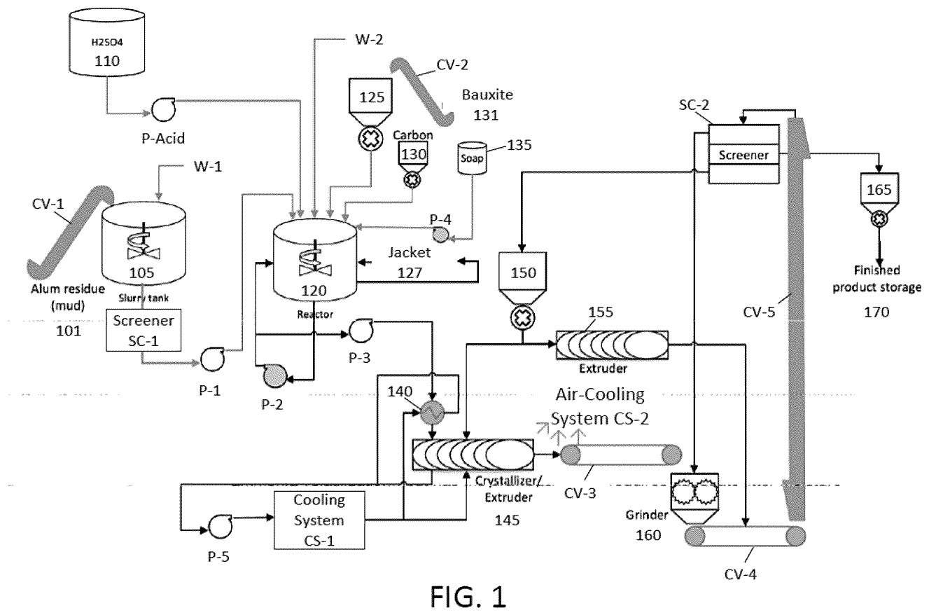

FIG. 1 illustrates a system that can be used to refine alum process residue (mud/sludge) into useable constituent compounds. Apparatus used to perform such refinement may include slurry tank 105, reaction tank 120, acid storage tank 110, one or more water sources (W-1 & W-2), a plurality of pumps (P-Acid, P-1, P-2 P-3, P-4, & P5), crystallizer/extruder apparatus 145, an extruder 155, grinder 160, one or more screeners (SC-1 & SC-2), various conveyors (CV-1, CV-2, CV-3, CV-5, & CV-5), bauxite storage tank 125, carbon storage tank 130, soap storage tank 135, temporary storage tank 150, product storage tank 165, and final product storage 170. Materials provided to such a system include, for example, alum process residue (mud) 101, an acid (e.g., sulfuric acid: H₂SO₄), bauxite or a hydrate material 131, water, activated carbon, and possibly soap. Soap may be added to reaction tank 120 to control foaming of the product.

Initially, an alum process residue 101 and water is provided to the slurry tank of FIG. 1. The alum process residue 101 can be material recovered from other manufacturing processes that include commercially viable constituent compounds. This alum process residue 101 that is refined can be present in the form of a mud or sludge-like material that is provided to slurry tank 105 using conveyor CV-1. Water may be provided from any suitable source W-1, such as a city water system or a water tank.

The slurry tank 105 may include an agitator that mixes the alum process residue mud 101 material with the water when an alum process residue 101 slurry is introduced to reaction tank 120 via screener SC-1 and pump P-1. Once a threshold percentage of solids in the slurry tank has been achieved and the materials in the slurry tank are adequately mixed, the diluted sludge (now slurry) may be pumped from the slurry tank 105 to reaction tank 120. One or more rules for generating the slurry may be considered a recipe that specifies upper and/or lower solid percentage thresholds. For example, concentrations of aluminum oxide in the slurry tank may be controlled to be within an upper and a lower threshold concentration. Recipes can be adjusted over time based on analysis performed on the final product. This analysis can identify whether the final product meets product specification and performance requirements. The mass of particular materials that are provided to the reaction tank can be specified in a recipe. Among others, such recipes can identify weights of acid, slurry, bauxite, soap, activated carbon, and/or other materials used to produce a product.

Screen SC-1 coupled to an output of slurry tank 105 may be used to filter materials exiting slurry tank 105. A pump (P-1) coupled to the slurry tank screen/screener SC-1 can be used to pump the slurry to reaction tank 120.

Reaction tank 120 also contains an agitator that mixes the alum process residue slurry with an acid (e.g., H₂SO₄), water, and a material that contains aluminum oxide (e.g., bauxite or a hydrate material). Here, the acid can be provided from an acid storage tank 110 (e.g., an H₂SO₄ tank) with the acid being pumped from acid storage tank 110 to reaction tank 120 with a pump (P-Acid) that is capable of pumping the acid (e.g., an H₂SO₄ pump). Other materials such as soap and carbon may also be provided to the reaction tank 120, for example from soap tank 135 or carbon tank 130. Water is provided to reaction tank 120 from an available water source (e.g., water source W-2). The acid that is provided to the reaction tank initiates a chemical reaction that dissolves materials contained within the reaction tank as product is formed. As mentioned above, soap may be added to control foaming. Activated carbon may be added at the end of a batch to help reduce deterioration of residual free acid that may be included in the product.

The system of FIG. 1 can be used to batch-process the input materials; namely, alum process residue 110. Note that source materials provided to the reaction tank can be agitated into a slurry with the agitator of the reaction tank 120 at any desired pressure. In one example, the source material is agitated into a slurry under atmospheric pressure conditions and in another example the reaction tank is pressurized above atmospheric pressure. The reaction tank includes one or more heating/cooling elements or jackets. To control the reaction tank, steam can be provided to heat transfer jacket 127 of reaction tank 120 to heat the reaction components. Water can be provided via water input W-2 to reaction tank 120 to help cool the reaction components. Water can also be used to heat transfer jacket 127 of the reaction tank 120 or to cool the reaction components. In certain instances, pressure within the reaction tank is controlled using check valves that open or vent at a specific or selected pressure.

One or more sensors are coupled to the reaction tank or to an apparatus that provides materials to the reaction tank. As such, load cells and flowmeters are used to monitor quantities of raw materials added to reaction tank 120. Quantities of materials that contain aluminum oxide (e.g., an alum mud slurry, bauxite, and/or other material) and water may be determined based on weight. Pressure and temperature sensors/transmitters can be used to sense pressures and temperatures of the reaction tank when a reaction occurring in the reaction tank is being monitored. Generally, actions taken when a reaction is performed may include:
1. Pump an alum process residue mud slurry into the reaction tank through a screener to remove larger particles that could affect the process;
2. Add Water to the reaction tank;
3. Add bauxite or other aluminum containing material to the reaction tank (for example using a screw conveyor {i.e., an Archimedes screw});
4. Add acid to the reaction tank, possibly with a dosing or metering pump;
5. Allow the reaction to initiate while controllably adding water. This can include monitoring temperature, pressure, and weight of the reaction tank as the reaction occurs. Weight of the reaction tank is controlled as the reaction occurs. Since the temperature inside the reaction tank can increase based on the reaction being exothermic, masses of gas or vapors generated by the reaction can be replaced by adding more water. Gases or vapors (e.g., water vapor) generated by the reaction may be vented while the additional water is added to the reaction tank;
6. Add Activated carbon to the reaction vessel, for example, at the end of a batch; and
7. Pump the resulting product out of the reaction tank, potentially at an above-ambient temperature.

The product produced in the reaction tank is pumped to a crystallizer or other device that allows the product to solidify. Pumps P-2 and/or P-3 are used to pump the product output from reactor 120 when the product is made. Portions of the produced product flow can be recirculated back to the reaction tank based on the operation of pump P-2. Such a recirculating operation can be used to help avoid plugging issues. With respect to FIG. 1, the product produced in the reaction tank 120 is conveyed using a positive displacement pump P-3 into crystallizer/extruder 145 where that product cools down and solidifies in the crystallizer/extruder 145. An extruder or pugmill portion of crystallizer/extruder 145 is used to crystallize (solidify) the product as it is provided to conveyer CV-3. This typically results in particles of different sizes being produced. As such, some small (less than a threshold size) particles and some larger (greater than the threshold size) particles can be formed. In certain instances, equipment other than the afore-mentioned crystallizer and/or extruder are used to cool the product into solid particles.

An external heat exchanger can be used upstream of the crystallizer to provide additional cooling. This upstream heat exchanger can be coupled to the crystallizer/extruder 145 of FIG. 1. For example, cooling system CS-1 can provide a cooling fluid to a cooling jacket of crystallizer extruder 145. As such, the crystallizer may include a cooling jacket that is coupled to a pump (e.g. pump P-5) that circulates a fluid that transfers heat to “cooling system CS-1.” In such instances, a radiator and/or chiller device may be used. Air-cooling system CS-2 may be used upstream and/or downstream of the crystallizer/extruder 145. This air-cooling system CS-2 can be used to dry the product on conveyor CV-3. AL+ Clear Plus (ACP) product particle fines can be recycled in the equipment of FIG. 1 where particles of the product are reformed.

One or more valves of valve set 140 can be used to control flows of coolant between cooling system CS-1 and a cooling jacket of crystallizer/extruder 145. One or more other valves of valve set 140 may be used to control the flow of product from reaction tank 120 to crystallizer/extruder 145. One example of the type of cooling systems that can be used in a system consistent with FIG. 1 include (but is not limited to) a liquid chilling system that provides a chilled liquid to the reaction. Another example is an air blowing system that blows air over a heat exchanger or radiator to cool the reactor. For liquid cooling system CS-1, a fluid chilling device provides cooling fluid to a jacket about crystallizer/extruder 145. Cooling system CS-2 includes fans that blow cooling air through a radiator coupled to extruder 155 of FIG. 1. Cooling system CS-1 is referred to as an upstream cooling system and cooling system CS-2 is referred to as a downstream cooling system. This terminology is used because the functions of crystallizer/extruder 145 occur before product is cooled by air at conveyer CV-3 or at extruder 155.

Next a grinding and screening process is performed. Particles are provided to grinder 160 of FIG. 1 via conveyor CV-3 coupled to crystallizer/extruder 145 and grinder 160 that provides ground up particles to conveyer CV-4. As such, these particles can be provided to a grinder that is downstream of a crystallizer. Particles can be transferred from conveyer CV-4 to conveyer CV-5 and then to screener SC-2. Screener SC-2 may be used to control the particle size and to increase the efficiency of the system because only fines that correspond to threshold sizes may be passed to finished product storage 170. In certain instances, a filter may be used to remove particles that have dimensions that are smaller than a lower threshold size. Oversized particles (particles larger than a threshold size) can be cycled between the grinder 160 and the screener SC-2 several times until they are reduced to the prescribed large-size threshold. In certain instances, fines are recirculated through the system and reformed in the crystallizer/extruder 145 or in another extruder 155 into larger consolidated particles. In this case the process includes moving particulate from screener SC-2 to vessel 150 until the particles can be moved to either crystallizer/extruder 145 or to extruder 155. As such, particles move through one or more pathways when a final product is prepared. Examples of these pathways include, but are not limited to:
crystallizer to grinder, grinder to screener, and screener to finished product storage;
crystallizer to grinder, grinder to screener, screener to crystallizer, crystallizer to grinder, grinder to screener, and screener to finished product storage; and/or
crystallizer to grinder, grinder to screener, screener to extruder, extruder to screener, and screener to finished product storage.

After the produced product particles have been adequately filtered and screened to appropriate sizes and in compliance with product specifications, the product can be packaged for shipping or storage. As such, product is provided from screener SC-2 to vessel 165 and then to finished product storage 170 based on the product conforming to a set of size requirements.

The sensors discussed above are coupled to the computer of an automated control system. The computer controls the delivery of materials to the slurry tank and identifies when the slurry includes the threshold percentage of solids. This computer can also control delivery of materials to the reaction tank, can monitor pressures and/or temperatures of a reaction occurring in the reaction tank, can also control recycling of materials out of and back into the reaction tank, and can identify when a reaction is complete. The computer controls delivery of products produced in the reaction tank and controls delivery of those products to the crystallizer. Furthermore, the computer monitors and/or controls the various pathways discussed above that can be used to filter, grind, or otherwise produce a product that corresponds to threshold size(s).

Chemical reactions monitored using systems and techniques described in the present disclosure can be based on relative masses of materials added to the reaction vessel. These chemical reactions can be described using molar mass equations. Such chemical reactions reorder the atomic structure of elements when one compound changes into another compound. For example, aluminum (Al(OH)3) contained within a first compound may be changed into aluminum sulfate (Al₂(SO₄)₃) by adding sulfuric acid (H₂SO₄). When aluminum oxide and sulfuric acid are mixed in the reaction vessel, the sulfuric acid dissolves the aluminum oxide, and this generates aluminum sulfate Al₂SO₄. This generally is expressed according to the chemical equation Al(OH)3+H₂SO₄→H₂O+Al₂(SO₄)₃. This equation is not balanced, however, because there are more sulfate SO₄ ions on the right side of the equation than on the left side of the equation.

A balanced equation expressing the reaction is 2Al(OH)3+3H₂SO₄→6H₂O+Al₂(SO₄)₃. Generally, some aluminum or other compounds remain unreacted, and this results in free acid or acidic compounds being left behind when aluminum sulfate is generated as the final. Activated carbon can be provided to vessel or tank where a chemical reaction occurs to reduce the free acid deterioration over time. Some of the added activated carbon can also absorb ammonia when the product is used in certain applications. The manufacturing process can be controlled such that product made by the chemical reaction conforms to purity standards, requirements, and/or rules. In certain instances, the final product can have a 10% to 14% concentration of aluminum oxide (Al₂O₃) by weight.

Similar evaluations can be made when determining masses of input materials that contain aluminum oxide and are dissolved in sulfuric acid. This means that if one knows a mass of aluminum that is provided to a reaction vessel, one can determine a mass of sulfuric acid that should be provided to the reaction vessel to convert all of the aluminum into aluminum sulfate. Systems and techniques of the present disclosure can be used to account for particular materials that are provided to a reaction vessel. As discussed above, aluminum containing materials added to the reaction vessel (e.g., reaction tank 120 of FIG. 1) may include Alum mud residue or other aluminum containing material (e.g., bauxite). The masses of specific materials being added to the reaction vessel can be varied based on the chemical composition of those specific materials. Such techniques may also call for adding water to the reaction vessel. As before, these chemical reactions proceed according to molar equations and respective masses of particular elements or compounds included in the materials input into the reaction vessel.

The process of dissolving compounds that include aluminum (e.g., aluminum hydroxide, Alum residue, bauxite, or other aluminum containing material) can be performed by providing specific masses of specific materials to the reaction vessel. Methods of the present disclosure measure the weight of the reaction vessel as different materials are added to the vessel. Because of this, an automatic control system or an operator that controls the delivery of materials to the reaction vessel can control chemical reactions used to produce material that is output from a chemical processing system.

Since chemical reactions of the present disclosure are exothermic, once a reaction has started, the chemical reaction can output heat. Amounts of heat output by an exothermic reaction can be identified by measuring temperature changes within the reaction vessel. The energy (“E”) released by a chemical reaction is described by the formula: E=(Energy released per chemical reaction)*(1/[number of moles of reactant used])*(Mass of Reactant/[molar mass of the reactant]). Furthermore, the energy released by a chemical reaction will result in a temperature change in the reaction vessel that corresponds to the energy released by the chemical reaction. Because of this, changes in temperature within the reaction vessel can be used to validate that an expected chemical reaction has occurred to a desired extent.

In the case where respective masses of aluminum and sulfuric acid are combined, an amount of energy released by this reaction can be expected to result in a rise in temperature within the reaction vessel. Such a temperature change can be expected based on energy equations that consider molar masses of compounds reorganized by the chemical reaction. This means that changes in temperature may be used to identify whether a particular set of inputs to the reaction vessel corresponds to production expectations. For example, in an instance when a mass of Alum is believed to contain X grams of aluminum yet actually contains only X/4 grams of aluminum, an observed change in temperature of an associated chemical reaction that occurs when the Alum is mixed with sulfuric acid will not correspond to expectations because only a fourth of an expected chemical reaction would occur.

It may also be needed or desired to actively control the temperature of the reaction vessel during or after the chemical reaction has occurred. Such a need or desire, however, may interfere with the accuracy of determinations made based on temperature change measurements and molar equations. Because of this, the techniques taught by the present disclosure can be initiated when neither steam nor a cooling fluid is provided to a heating/cooling jacket of the reaction vessel, inputs may be provided to the reaction vessel, and temperatures within the reaction vessel may be monitored overtime. As the chemical reaction proceeds, temperatures within the reaction vessel may increase because of the exothermic reaction. Observed temperature changes per unit time may be used to identify that the reaction is proceeding as expected. In instances when it is desired to maintain the temperature within the reaction vessel within a temperature range, cooling fluid can be provided to the heating jacket to control the temperature within the reaction vessel.

A computer may be coupled to various sensors of a processing system according to the teachings of the present disclosure. One set of sensors may measure the weight of the reaction vessel such that masses of materials provided to the reaction vessel may be identified. Another set of sensors may be used to measure the temperature of the reaction vessel, temperatures of constituent components provided to the reaction vessel, and/or temperatures of heating or cooling liquids provided to the jacket of the reaction vessel.

Processors of the computer may be used to control or monitor movement of materials provided to the reaction vessel. In some instances, these processors make determinations based on energy and/or molar mass equations as discussed above. In other instances, the processors of the computer implement functions of machine learning (ML) and/or artificial intelligent (AI). Over time, data will be collected that allows the processors of the ML or AI system(s) to identify masses of respective materials provided to the reaction vessel and/or identify various temperatures associated with or used to control the chemical reaction or other apparatus of the processing system.

Rates of change may be used to monitor, control, and/or update operation of the processing system dynamically based on data sensed by the sensors of the processing system. As such, an ML computer model may be trained based on data collected when the processing system operates either under the control of the computer or an operator. Once the ML computer model is trained, the processing system can operate in an autonomous or semi-autonomous mode.

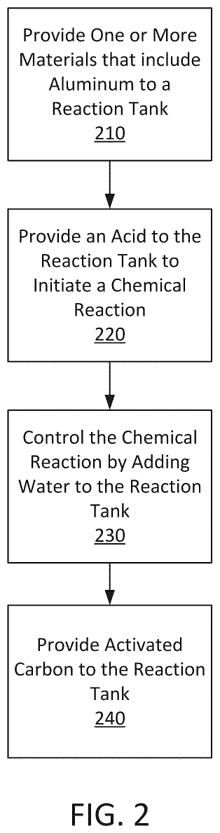

FIG. 2 illustrates, via flowchart, a series of actions performable when a product is made from materials that include aluminum or aluminum oxide. At block 210, one or more materials that include aluminum are provided to the reaction tank/vessel. The one or more materials provided to the reaction tank can include alum. The alum material may be mud or sludge that contains a controlled density of aluminum or aluminum oxide (e.g., The concentration of mud in the slurry may be controlled to include 30% to 40% solids by volume or weight). Water added to the slurry tank can be controlled to maintain the viscosity or percentage concentrations of solids of the mud. The alum mud can contain relatively low densities of aluminum as compared to other aluminum-containing materials (e.g., bauxite or other aluminum oxide containing material) that can be added to the reaction vessel. In certain instances, both alum and other aluminum-rich materials (e.g., bauxite or alumina hydrate) can be provided to the reaction tank at block 210. In certain instances, water may also be provided to the reaction tank.

A scale or load cell may be used to monitor the weight of the reaction tank as respective materials are added to the tank. Other measurements may also be made, for example the masses of materials may be estimated based on operation of an auger or Archimedes screw conveyance. Weights of tanks from which various materials are provided may also be monitored by sensors and data from those sensors can be provided to or otherwise accessed by a control system. Control systems of the present disclosure can monitor weight of the reaction tank to identify masses of specific materials that are included in the reaction tank. Based on this, masses of alum, bauxite, and/or water present in the reaction tank can be known. Water may also be added to the reaction tank to provide dilution liquid that an agitator included in the reaction tank can be used to mix the materials included in the reaction tank more easily. The reaction tank may also be heated or cooled to control the temperature of the reaction tank.

Initially, the reaction tank may be heated by providing steam to a jacket about the reaction vessel. Acid is provided to the reaction tank at block 220 of FIG. 2. At this time both the temperature of the reaction tank and the weight of the reaction tank can be monitored. Acid is provided to the reaction tank to initiate a chemical reaction. Since this reaction is exothermic, the temperature of the reaction vessel will increase as gases and/or vapors are created in the reaction tank. In certain instances, these gases and/or vapors (e.g., water vapor) can be vented or otherwise be output from the reaction tank.

As the chemical reaction continues, the weight of the reaction tank can be measured and water may be added to the reaction vessel at block 230 to maintain the weight of the reaction tank within a desired weight range. The temperature of the reaction vessel may also be measured. A computer monitoring the weight of the reaction vessel and temperature over time may make estimates as to whether or not the chemical reaction is complete or complete enough to begin outputting product from the reaction tank. Carbon or activated carbon may be provided to the reaction tank at block 240. Masses of the carbon added to the reaction tank may be controlled based on estimates of masses of other compounds included in the reaction tank. A mass of activated carbon added may be based on the total weight and a recipe may dictate that the activated carbon included in a batch corresponds to about 0.5% of that total weight. The activated carbon can reduce deterioration of free acids or acidic compounds in the final product and can also act to absorb ammonia when the product is used in certain applications. Activated carbon may be used to reduce the deterioration of the residual free acid in the reaction tank. Masses of aluminum and/or other materials included in the reaction tank may be estimated based on measured weights of respective aluminum-containing materials that are added to the reaction tank and estimated densities of contained aluminum and/or other compounds included in those materials.

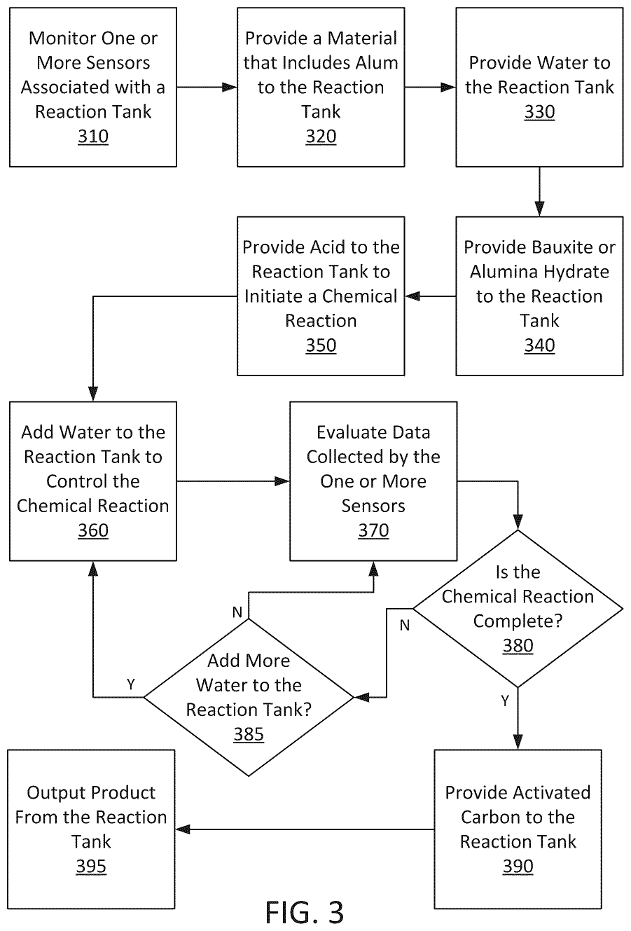

FIG. 3 illustrates, via flowchart, actions that may be performed when a product is made from aluminum-containing materials. At block 310, one or more sensors associated with a reaction tank are monitored. As mentioned above, these sensors can include a scale or load cell that senses pressure from which the weight of the reaction tank can be determined. At block 320 an alum mud is added to the reaction tank, at block 330 water is added to the reaction tank, at block 340 bauxite (or other material that contains aluminum such as alumina hydrate) can be added to the reaction tank, and at block 350 acid is provided to the reaction tank. Weights of the reaction tank may be monitored when masses of compounds included in the reaction tank are estimated. As such, masses or weights of alum mud, water, bauxite (or other material) and acid added to the reaction tank can be identified by measuring weight.

As the chemical reaction proceeds and weight of the reaction tank reduces, additional water is added to the reaction tank at block 360. The water is added to maintain the weight of the reaction tank to within a prescribed weight range. At block 370, data collected by the one-or-more sensors is evaluated. This evaluation is performed such that a determination can be made at block 380 as to whether the chemical reaction is complete enough to begin outputting product. If yes, activated carbon is added to the reaction tank at block 390. The mass of carbon added to the reaction tank can be identified by a change in weight of the reaction tank. In some instances, the mass of carbon added may be determined based on process capabilities of a conveyance apparatus. The masses of these substances added to the reaction tank may be according to a manufacturing process profile and/or chemical equations. Masses of specific materials added to the reaction tank will correspond to a set of chemical equations and the mass of product produced will be a function of available aluminum, acid, and/or carbon such that the product is produced according to the set of prescribed chemical equations.

As such, based on the evaluations performed at block 370, a determination can be made at block 385 as to whether the chemical reaction is complete or not. When the chemical reaction is complete, activated carbon can be added to the reaction tank at block 390, and product may be output from the reaction tank at block 395. When an assessment is made at block 380 that the chemical reaction is not complete, then a determination will be made whether more water should be added to the reaction tank at block 385. When determination block 385 identifies that more water should be added to the reaction tank, program flow moves to block 360 where additional water is added to the reaction tank. When determination block 360 identifies that more water should not be added to the reaction tank, program flow moves to block 370 where the data collected by the one or more sensors is evaluated again. This will continue until the chemical reaction is complete and product is output from the reaction tank.

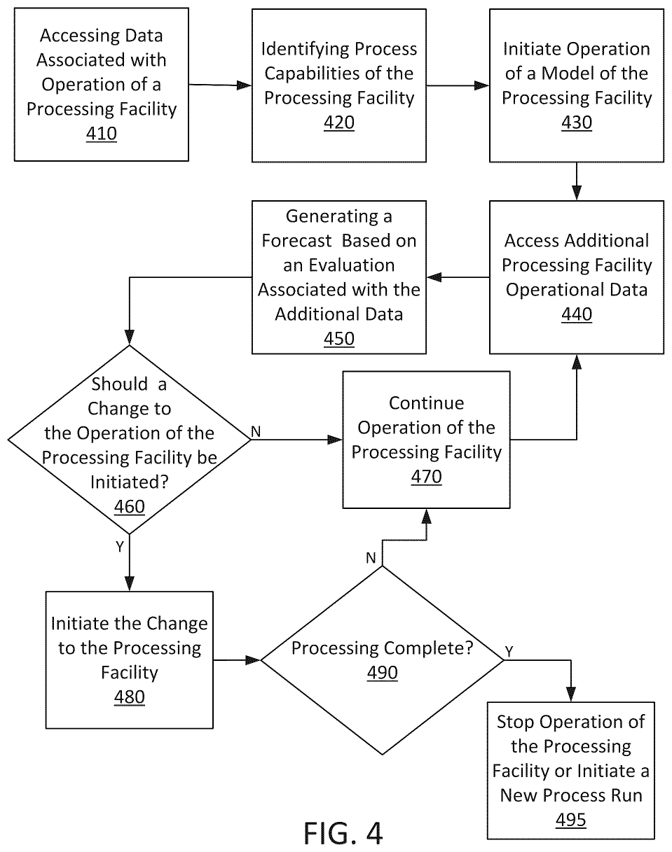

FIG. 4 illustrates, via flowchart, operations performable by the presently disclosed system that controls operations of an alum processing facility. Such a system includes one or more processors that perform evaluations on collected data to increase the efficiency of the alum processing facility. These processors may access data sensed by one or more sensors when actions discussed with respect to FIG. 2 and FIG. 3 are performed. Sensors of the alum processing facility can measure the weight of the reaction tank when various materials are added thereto and sensors are also used to measure the temperature of the reaction tank as a chemical reaction occurs. Other sensors sense the temperature of fluids provided to a heat transfer jacket of the reaction tank. In certain instances, respective sensors sense the temperature of a coolant (e.g., coolant water) and the temperature of a heating fluid (e.g., steam) that may selectively be provided to the heat transfer jacket of the reaction tank.

Data collected from numerous operational cycles of the alum processing facility can be accessed at block 410 of FIG. 4. This data can be evaluated to identify rates of change or processing capabilities of a processing facility at block 420. Such data may include a set of initial starting conditions that identify a mass of alum, a mass of water, a mass of bauxite and a mass of acid provided to the reaction tank, as well as data representing a starting temperature of the reaction tank. These initial starting conditions combined with operational constraints of the system can each contribute to how efficiently and effectively the product output by the processing facility is produced. One operational constraint is associated with maintaining a prescribed temperature in the extraction vessel within an acceptable operational temperature range. A temperature that is too low runs a risk of the product solidifying too quickly and causing processing equipment to seize. A temperature that is too high can pose a risk of the product not crystalizing in a manner that allows equipment like the crystallizer and/or the extruder discussed above to form product that is sufficiently solidified.

At block 430 a model of the operation of the processing facility is initiated. According to the present technology, the model is a computer model in which processors of a computer execute instructions of a ML or AI process. At block 440 additional processing operational data can be accessed such that operation of the processing facility continues or performs updates based on forecasts made by the model.

When an exothermic chemical reaction is initiated in the reaction tank, the temperature within the reaction tank can rise. Rates of change of temperature may be observed from collected data at block 440. Such rates of change correspond to expectations associated with energy released by the chemical reaction and this may be affected by the initial conditions within the reaction tank. To maintain the temperature within the reaction tank within the prescribed temperature range, a heating or coolant fluid may be provided to the heat transfer jacket of the reaction tank. This can help control a chemical reaction taking place inside the reaction tank. This includes adding water to the reaction tank to help control the temperature therein. Another constraint that may be applied to operation of the processing facility is maintenance of the weight of the loaded reaction tank within a prescribed (or otherwise established) weight range. The weight range can correspond to the initial weight of the reaction vessel plus or minus some weight tolerance (e.g., plus or minus 5 percent). As such, the initiation weight plus or minus some percentage can be referred to as a target weight range and such a weight range will typically be consistent with a prescribed recipe for making a particular product. Water may be added to the reaction tank to maintain the weight of the reaction tank within the weight tolerance.

Multiple factors can affect how fast temperature changes occur within the reaction vessel. Such factors may include the temperature or thermal mass of a cooling fluid, the temperature or thermal mass of a steam source, heat transfer coefficients of the reaction tank's heat transfer jacket, chemical reaction rates, and/or the temperature and/or mass of water added to the reaction tank.

The computer model can be generated to approximate changing conditions in the reaction vessel as a function of the initial conditions and measured changes over time. The computer model can be used to generate an artificial intelligent (AI) or machine learning (ML) system capable of performing evaluations on sets of collected data. A control system of the present disclosure may include or be part of the AI or ML system that makes determinations regarding how to control inputs to the reaction tank, a crystallizer, and/or an extruder of the processing system. Data from iterative processing runs may be used to identify time rates of change of energy output from an exothermic reaction, rates of thermal transfer from a heating source (e.g., a steam boiler) or a cooling source (e.g., a water source) to a heat transfer jacket of the reaction tank. Masses of water required to maintain both the temperature and weight of the reaction tank within respective ranges or thresholds may also be identified. Operation of the AI or ML system can result in reducing variations in both temperature and weight of the reaction tank during a production cycle.

A control system can be used to monitor and control masses of carbon (e.g., activated carbon) that are added to the reaction vessel. The control system may also control the timing when the carbon is added to the reaction vessel. The introduction of carbon into the reaction vessel is used to affect the purity and content of the product made by the processing system. The carbon is added to absorb residual acid or to mitigate the formation of acidic compounds. As such, the product produced from the described process can increase the useful life span of the product by helping prevent free acid deterioration of the product. Residual carbon still present in the produced product can be used to absorb ammonia in certain end-uses and customer sites, where desirable. Such residual carbon in finished product can be used to absorb ammonia that could otherwise negatively affect captive animals. For example, when the product is used as a treatment to manage poultry litter, the presence of carbon in the product enables the absorption of more ammonia as compared to similar products not having residual carbon. As such, the product helps control ammonia levels in poultry houses thereby improving the health of birds exposed to the product.

Concentrations of aluminum oxide (Al₂O₃) can be advantageously maintained within a range of 10 to 14 percent in the reaction tank when there is a presence of about 3 percent free acid. Such conditions have been found to increase rates of ammonia absorption.

Concentrations of mud in a slurry tank can be controlled by an operator or by the control system. Controlling the concentration of mud in the slurry tank is used to help control the rate of the chemical reaction in the reaction tank. An operator or the control system can also control how fast material is provided to an extruder. Product may be fed to the extruder (for example from a crystallizer) at a controlled rate that allows the product to dry. In this case, the extruder is used to control the cooling rate of the product as the dry product is produced. For example, the rate at which an extruder and/or a crystallizer is run, environmental temperatures, or temperatures of one or more cooling systems can affect the cooling rate of the product.

After additional operational data of the processing facility has been accessed at block 440, a forecast associated with continued operation of the processing facility is performed at block 450. This forecast can be performed to determine whether a change to the operation of the processing facility should be made. Determination block 460 may then identify whether the operation of the processing facility should be changed. When a determination is made at determination block 460 that a change is not required, program flow moves to block 470 where operation of the processing facility is continued. When the determination made at block 460 identifies that a change should be made to the processing facility, that change is implemented at block 480. Changes to the operation of the processing facility can be made by operation of an automatic control system. Such changes can include changing flows of heating or cooling fluids to the reaction vessel. These changes can also include changing flows of coolant to a crystallizer or extruder or changing rates at which materials are moved from one piece of equipment to another piece of equipment as the processing facility produces a product.

After the change has been initiated at block 480, a determination as to whether the processing of the product is complete is made at determination block 490 of FIG. 4. When processing is complete, operation of the processing facility can be stopped or another new process run can be initiated at block 495. When processing is not complete, program flow moves from determination block 490 back to block 470 where operation of the processing facility is continued. When the operation of the processing facility is continued, processors of the control system access additional operational data at block 440 such that additional forecasts and/or changes to the operation of the processing facility can be performed.

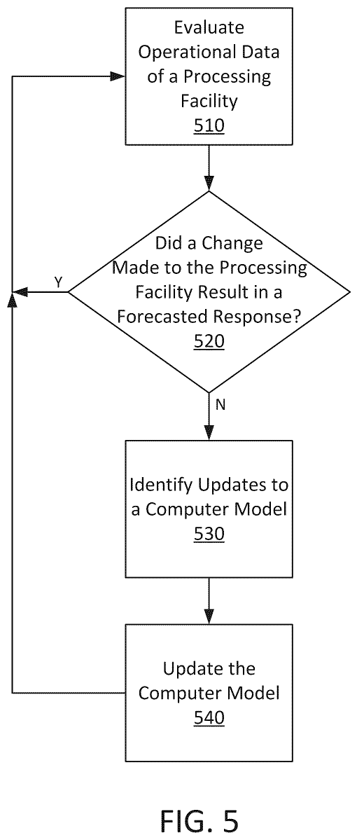

FIG. 5 illustrates, via flowchart, actions of a machine learning process that allows for the operation of a computer model to be updated. The actions of FIG. 5 can be performed when the computer model used to control the operation of a processing facility is trained. At block 510, operational data of the processing facility can be evaluated. This evaluation may compare forecasts to actual measured results such that determinations are made as to whether the computer model should be updated. For example, when the computer model forecasts that heat should be applied to the heat transfer jacket of the computer model to control a rate of change of temperature and when operational data of the processing facility does not correspond to a forecasted rate of change of the temperature, heat transfer coefficients or other factors of the computer model can be updated. Such updates to the computer model result in modified behavior of the control system the next time a set of similar conditions are observed. For example, the next time the temperature of the reaction tank is observed reducing at a given rate, either the timing relating to when heat is applied to the heat transfer jacket can be adjusted or a volume of heating fluid provided to the heat transfer jacket may be increased.

As such, based on the evaluations performed at block 510, a determination as to whether a change made to the processing facility corresponds to a forecasted response can be made at block 520. When a determination is made that that change did result in a response that corresponds to the forecast, program flow can move to block 510 where additional operational data of the processing facility is again evaluated. When determination block 520 identifies that the change did not result in a response that corresponds to the forecast, program flow moves to block 530 where updates to the computer model are identified. Based on this, the computer model can be updated at block 540 of FIG. 5.

Various sources of heated or cooled fluids may be used. For example, a boiler that generates steam by burning natural gas may be used to heat a reaction tank. In other instances, electrical energy may be used to heat the reaction tank or to generate steam that is used to heat the reaction tank. In various instances, chilled liquid can be provided from a liquid source (e.g., a water source) or the chilled liquid could be cooled by operation of an industrial chiller. Furthermore, various parts of an apparatus may be heated or cooled. For example, a chilled liquid can be provided to a heat transfer jacket of the reaction vessel. In some instances, the chilled fluid is provided to an agitator that is located within a vessel such as the reaction tank 120 of FIG. 1. In some instances, the chilled liquid includes ethylene glycol.

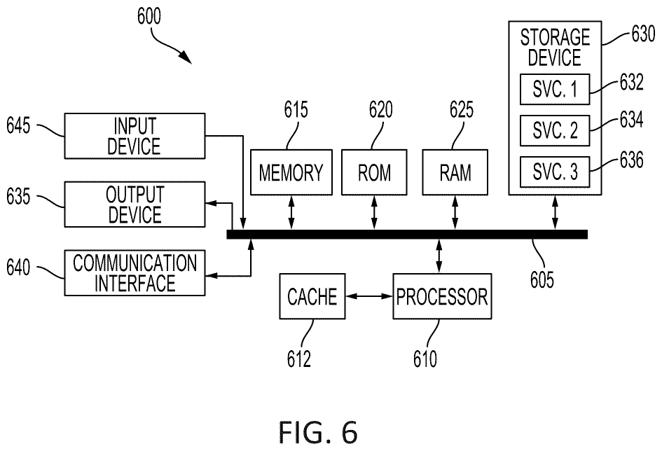

FIG. 6 illustrates an example computing device architecture that can be employed to perform any of the systems and techniques described herein. In some examples, the computing device 600 architecture can be integrated with tools described herein. The components of the computing device architecture 600 are shown in electrical communication with each other using a connection 605, such as a bus. The example computing device architecture 600 includes a processing unit (CPU or processor) 610 and a computing device connection 605 that couples various computing device components including the computing device memory 615, such as read only memory (ROM) 620 and random access memory (RAM) 625, to the processor 610.

The computing device architecture 600 can include a cache of high-speed memory connected directly with, in close proximity to, or integrated as part of the processor 610. The computing device architecture 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other computing device memory 615 may be available for use as well. The memory 615 can include multiple different types of memory with different performance characteristics. The processor 610 can include any general-purpose processor and a hardware or software service, such as service 1 632, service 2 634, and service 3 636 stored in storage device 630, configured to control the processor 610 as well as a special-purpose processor where software instructions are incorporated into the processor design. The processor 610 may be a self-contained system, containing multiple cores or processors, a bus, memory controller, cache, etc. A multi-core processor may be symmetric or asymmetric.

To enable user interaction with the computing device architecture 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art, such as a display, projector, television, speaker device, etc. In some instances, multimodal computing devices can enable a user to provide multiple types of input to communicate with the computing device architecture 600. The communications interface 640 can generally govern and manage the user input and computing device output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof. The storage device 630 can include services 632, 634, 636 for controlling the processor 610. Other hardware or software modules are contemplated. The storage device 630 can be connected to the computing device connection 605. In one aspect, a hardware module that performs a particular function can include the software component stored in a computer-readable medium in connection with the necessary hardware components, such as the processor 610, connection 605, output device 635, and so forth, to carry out the function.

For clarity of explanation, in some instances the present technology may be presented as including individual functional blocks including functional blocks comprising devices, device components, steps or routines in a method implemented in software, or combinations of hardware and software.

In some instances, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples and aspects thereof, but those skilled in the art will recognize that the application is not limited thereto. Thus, while illustrative examples and aspects of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples and aspects of the systems and techniques described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Methods and apparatus of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Such methods may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Aspects of the present disclosure include:
Aspect 1: A method comprising providing an aluminum containing material to a reaction tank; providing acid to the reaction tank to initiate a chemical reaction; controlling the chemical reaction by providing water to the reaction tank and providing activated carbon to the reaction tank.
Aspect 2: The method of Aspect 1, further comprising: monitoring a weight of the reaction tank; identifying that additional water should be added to the reaction tank to maintain the weight of the reaction tank within a target weight range; and providing the additional water to the reaction tank to maintain the weight of the reaction tank within the target weight range.
Aspect 3: The method of Aspect 1 or 2, further comprising: identifying an initial weight of the reaction tank; and monitoring the weight of the reaction tank while: the aluminum containing material is provided to the reaction tank, the acid is provided to the reaction tank, and the activated carbon is added to the reaction tank, wherein a measure of the aluminum containing material, a volume of the acid, and a mass of the activated carbon provided to the reaction tank each correspond to a respective increase in the initial weight of the reaction tank.
Aspect 4: The method of any of Aspects 1 through 3, wherein a mass of aluminum included in the aluminum containing material provided to the reaction tank and a mass of the acid provided to the reaction tank correspond to a production profile.
Aspect 5: The method of any of Aspects 1 through 4, further comprising: monitoring a temperature of the reaction tank; identifying that a fluid should be provided to control the temperature of the reaction tank; and controlling movement of the fluid to the reaction tank to control the temperature of the reaction tank.
Aspect 6: The method of any of Aspects 1 through 5, further comprising adding a second aluminum containing material to the reaction tank.
Aspect 7: The method of any of Aspects 1 through 6, further comprising outputting a product from the reaction tank; and controlling movement of the product as the product solidifies.
Aspect 8: The method of any of Aspects 1 through 7, further comprising: initiating operation of a computer model that models operation of an aluminum oxide processing facility; accessing data associated with the operation of the aluminum oxide processing facility; identifying that a change to the operation of the aluminum oxide processing facility should be initiated; and initiating the change to the operation of the aluminum oxide processing facility.
Aspect 9: The method of any of Aspects 1 through 8, further comprising: accessing additional data associated with the operation of the aluminum oxide processing facility, wherein the change is associated with a forecast made based on the operation of the computer model; identifying that a response associated with the change does not correspond to the forecast; and updating the computer model based on the response associated with the change not corresponding to the forecast.
Aspect 10: The method of any of Aspects 1 through 9, further comprising: accessing data associated with continued operation of the aluminum oxide processing facility; and controlling operation of the aluminum oxide processing facility based on the operation of the computer model being updated.
Aspect 11: A system comprising: a reaction tank, and one or more inputs of the reaction tank, wherein: an aluminum containing material is provided to the reaction tank, an acid to the reaction tank to initiate a chemical reaction at the reaction tank, the chemical reaction is controlled by providing water to the reaction tank, and activated carbon is provided to the reaction tank.
Aspect 12: The system of Aspect 11, further comprising: a sensor that senses mass of the reaction tank and contents of the reaction tank; and a computer that includes one or more processors that execute instructions out of a memory of the computer to: monitoring a weight of the reaction tank based on data sensed by the sensor that senses the mass of the reaction tank and the contents of the reaction tank, and identify that additional water should be added to the reaction tank to maintain the weight of the reaction tank within a target weight range, wherein the additional water is provide to the reaction tank to maintain the weight of the reaction tank within the target weight range.
Aspect 13: The system of Aspect 11 or 12, further comprising: a scale that measures weight of the reaction tank, wherein the scale measures: an initial weight of the reaction tank is identified, a weight of the aluminum containing material provided to the reaction tank, a weight of the acid provided to the reaction tank, and a weight of the activated carbon is provided to the reaction tank, wherein the weight of the aluminum containing material, the weight of the acid, and the weight of the activated carbon provided to the reaction tank each correspond to a respective increase in the initial weight of the reaction tank.
Aspect 14: The system of any of Aspects 11 through 13, wherein a mass of aluminum included in the aluminum containing material provided to the reaction tank and a mass of the acid provided to the reaction tank correspond to a production profile.
Aspect 15: system of any of Aspects 11 through 14, further comprising: a temperature sensor that senses a temperature of the reaction tank, wherein: a temperature of the reaction tank is monitored, and fluid is moved to the reaction tank to control the temperature of the reaction tank.
Aspect 16: The system of any of Aspects 11 through 15, wherein a second aluminum containing material is provided to the reaction tank.
Aspect 17: The system of any of Aspects 11 through 15, further comprising: an output of the reaction tank that outputs a product from the reaction tank; and a conveyance that moves the product as the product cools.
Aspect 18: system of any of Aspects 11 through 17, wherein the one or more processor of the computer: execute the instructions to model operation of an aluminum oxide processing facility, access data associated with the operation of the aluminum oxide processing facility, identify that a change to the operation of the aluminum oxide processing facility should be initiated, and commands the change to the operation of the aluminum oxide processing facility be initiated.
Aspect 19: The system of any of Aspects 11 through 18, wherein the one or more processor of the computer: access additional data associated with the operation of the aluminum oxide processing facility, wherein the change is associated with a forecast made based on the operation of the computer model, identify that a response associated with the change does not correspond to the forecast, and update the computer model based on the response associated with the change not corresponding to the forecast.
Aspect 20: A non-transitory computer-readable storage medium having embodied thereon instructions that when executed by one or more processors result in: an aluminum containing material being controllably provided to a reaction tank; an acid being controllably provided to the reaction tank to initiate a chemical reaction wherein the chemical reaction is controlled by providing water to the reaction tank; and activated carbon being controllably provided to the reaction tank.

What is claimed is:

1. A method comprising:
providing an aluminum containing material to a reaction tank;
providing acid to the reaction tank to initiate a chemical reaction;
controlling the chemical reaction by providing water to the reaction tank; and
providing activated carbon to the reaction tank.

2. The method of claim 1, further comprising:
monitoring a weight of the reaction tank;
identifying that additional water should be added to the reaction tank to maintain the weight of the reaction tank within a target weight range; and
providing the additional water to the reaction tank to maintain the weight of the reaction tank within the target weight range.

3. The method of claim 1, further comprising:
identifying an initial weight of the reaction tank; and
monitoring the weight of the reaction tank while:
the aluminum containing material is provided to the reaction tank,
the acid is provided to the reaction tank, and
the activated carbon is added to the reaction tank, wherein a measure of the aluminum containing material, a volume of the acid, and a mass of the activated carbon provided to the reaction tank each correspond to a respective increase in the initial weight of the reaction tank.

4. The method of claim 3, wherein:
a mass of aluminum included in the aluminum containing material provided to the reaction tank and a mass of the acid provided to the reaction tank correspond to a production profile.

5. The method of claim 3, further comprising:
monitoring a temperature of the reaction tank;
identifying that a fluid should be provided to control the temperature of the reaction tank; and
controlling movement of the fluid to the reaction tank to control the temperature of the reaction tank.

6. The method of claim 1, further comprising:
adding a second aluminum containing material to the reaction tank.

7. The method of claim 1, further comprising:
outputting a product from the reaction tank; and
controlling movement of the product as the product solidifies.

8. The method of claim 1, further comprising:
initiating operation of a computer model that models operation of an aluminum oxide processing facility;
accessing data associated with the operation of the aluminum oxide processing facility;
identifying that a change to the operation of the aluminum oxide processing facility should be initiated; and
initiating the change to the operation of the aluminum oxide processing facility.

9. The method of claim 8, further comprising:
accessing additional data associated with the operation of the aluminum oxide processing facility, wherein the change is associated with a forecast made based on the operation of the computer model;
identifying that a response associated with the change does not correspond to the forecast; and
updating the computer model based on the response associated with the change not corresponding to the forecast.

10. The method of claim 8, further comprising:
accessing data associated with continued operation of the aluminum oxide processing facility; and
controlling operation of the aluminum oxide processing facility based on the operation of the computer model being updated.

11. A system comprising:
a reaction tank, and
one or more inputs to the reaction tank, wherein:
an aluminum containing material is provided to the reaction tank;
an acid to the reaction tank to initiate a chemical reaction at the reaction tank;
the chemical reaction is controlled by providing water to the reaction tank; and
activated carbon is provided to the reaction tank.

12. The system of claim 11, further comprising:
a sensor that senses mass of the reaction tank and contents of the reaction tank; and
a computer that includes one or more processors that execute instructions out of a memory of the computer to:
monitoring a weight of the reaction tank based on data sensed by the sensor that senses the mass of the reaction tank and the contents of the reaction tank; and
identify that additional water should be added to the reaction tank to maintain the weight of the reaction tank within a target weight range, wherein the additional water is provided to the reaction tank to maintain the weight of the reaction tank within the target weight range.

13. The system of claim 11, further comprising:
a scale that measures weight of the reaction tank, wherein the scale measures:
an initial weight of the reaction tank is identified;
a weight of the aluminum containing material provided to the reaction tank;
a weight of the acid provided to the reaction tank; and
a weight of the activated carbon is provided to the reaction tank, wherein the weight of the aluminum containing material, the weight of the acid, and the weight of the activated carbon provided to the reaction tank each correspond to a respective increase in the initial weight of the reaction tank.

14. The system of claim 13, wherein:
a mass of aluminum included in the aluminum containing material provided to the reaction tank and a mass of the acid provided to the reaction tank correspond to a production profile.

15. The system of claim 13, further comprising:
a temperature sensor that senses a temperature of the reaction tank, wherein:
a temperature of the reaction tank is monitored; and
fluid is moved to the reaction tank to control the temperature of the reaction tank.

16. The system of claim 11, wherein a second aluminum containing material is provided to the reaction tank.

17. The system of claim 11, further comprising:
an output of the reaction tank that outputs a product from the reaction tank; and
a conveyance that moves the product as the product cools.

18. The system of claim 12, wherein the one or more processor of the computer:
execute the instructions to model operation of an aluminum oxide processing facility;
access data associated with the operation of the aluminum oxide processing facility;
identify that a change to the operation of the aluminum oxide processing facility should be initiated; and
commands the change to the operation of the aluminum oxide processing facility be initiated.

19. The system of claim 18, wherein the one or more processor of the computer:
access additional data associated with the operation of the aluminum oxide processing facility, wherein the change is associated with a forecast made based on the operation of the computer model;
identify that a response associated with the change does not correspond to the forecast; and
update the computer model based on the response associated with the change not corresponding to the forecast.

20. A non-transitory computer-readable storage medium having embodied thereon instructions that when executed by one or more processors result in:
an aluminum containing material being controllably provided to a reaction tank;
an acid being controllably provided to the reaction tank to initiate a chemical reaction wherein the chemical reaction is controlled by providing water to the reaction tank; and
activated carbon being controllably provided to the reaction tank.
